(19) United States
(12) Patent Application Publication
(10) Pub. No.: US 2007/0285414 A1
(43) Pub. Date: Dec. 13, 2007

(54) Organic light emitting diode display and driving method thereof

(76) Inventors: Jae Sung Lee, Suwon-si (KR); Chang Hoon Lee, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/708,963

(22) Filed: Feb. 20, 2007

(30) Foreign Application Priority Data
Jun. 8, 2006 (KR) 10-2006-0051580

(51) Int. Cl. G06F 3/038; G09G 3/32; H04M 1/00

(52) U.S. Cl. 345/212; 345/204; 345/82; 455/566

(57) ABSTRACT

An organic light emitting diode display device used for a mobile phone display is disclosed. Battery life is prolonged by limiting the brightness of the picture on the mobile phone, thus reducing unnecessary power consumption when the mobile phone is in a telecommunications mode. In some embodiments, the amount of the limiting is dependent on image data.

### CROSS-REFERENCE TO RELATED APPLICATIONS

This application claims the benefit of Korean Patent Application No. 2006-0051580, filed on Jun. 8, 2006, in the Korean Intellectual Property Office, the disclosure of which is incorporated herein by reference.

### BACKGROUND OF THE INVENTION

1. Field of the Invention

The present invention relates to an organic light emitting diode display device and a driving method thereof, and more particularly to an organic light emitting diode display device whose luminance is limited while thing over the mobile phone to reduce a power consumption and in which the luminance is varied depending on the luminous area so that the telecommunication of the mobile phone is not unexpectedly cut off, and a driving method thereof.

2. Description of the Related Technology

A thin and light flat panel display device has been used for portable electric apparatuses such as mobile phones, etc., and a liquid crystal display and an organic light emitting diode display device have been widely known as the light flat panel display device. In particular, the organic light emitting diode display device uses an array of organic light emitting diodes to display an image, the organic light emitting diode being an autonomous light-emitting element that emits light to correspond to an electric current flowing to a plurality of organic layers. Accordingly, the organic light emitting diode display device has stood in the spotlight since it has a rapid response time, an excellent viewing angle and a low power consumption, compared to the liquid crystal display device.

### SUMMARY OF CERTAIN INVENTIVE ASPECTS

Some embodiments provide an organic light emitting diode display device capable of being used for a display on a mobile phone. Telecommunication of the mobile phone is prevented from being prematurely cut off by limiting the brightness of the picture on the display to prevent a unnecessary power consumption.

One embodiment is a organic light emitting diode display device for use in a mobile phone. The device includes a pixel unit having a plurality of pixels configured to receive a plurality of scan signals, a plurality of light emission control signals and a plurality of data signals to display an image. The device also includes a scan driver configured to transmit the scan signals and the light emission control signals to the pixel unit, a data driver including a video data configured to generate the plurality of data signals and to transmit the generated data signals to the pixel unit, a power source controller configured to determine whether the mobile phone is in a telecommunication mode, and a luminance controller configured to control an emission time of the pixel unit by determining a luminance limit of the pixel unit, the luminance limit corresponding to the size of the video data when the mobile phone is determined to be in a telecommunication mode.

Another embodiment is a method of driving an organic light emitting diode display device which displays an image on a mobile phone. The method includes determining whether the mobile phone is in a telecommunication mode, determining the sum of components of a data signal, and displaying the image at a time corresponding to the sum of the components of the data signal.

Another embodiment is a organic light emitting diode display device configured to be used for a mobile phone. The device includes a display controller configured to modify display power based at least in part on whether the mobile phone is in a telecommunication mode, where the display controller is configured to reduce the power if the video data indicates that a portion of the display device greater than a threshold is to be illuminated.

### BRIEF DESCRIPTION OF THE DRAWINGS

These and/or other aspects and advantages of the invention will become apparent and more readily appreciated from the following description of, taken in conjunction with the accompanying drawings of which:

FIG. 1 is a schematic view showing a conventional organic light emitting display device.

FIG. 2 is a schematic view showing an organic light emitting diode display device according to one embodiment.

FIG. 3 is a block diagram showing one embodiment of a luminance controller used for the organic light emitting diode display device.

FIG. 4 is a flowchart illustrating a method for driving the organic light emitting diode display device.

FIG. 5a through FIG. 5d are diagrams showing that an electric current capacity is limited to about 33% of the maximum electric current capacity of the organic light emitting diode display device.

FIG. 6a through FIG. 6d are diagrams showing that an electric current capacity is limited to about 33% of the maximum electric current capacity of the organic light emitting diode display device.

### DETAILED DESCRIPTION OF CERTAIN INVENTIVE EMBODIMENTS

Hereinafter, certain inventive embodiments will be described with reference to the accompanying drawings. Here, when one element is connected to another element, the one element may be not only directly connected to the other element but also indirectly connected to the other element via a third element. Further, some irrelative elements are omitted for clarity.

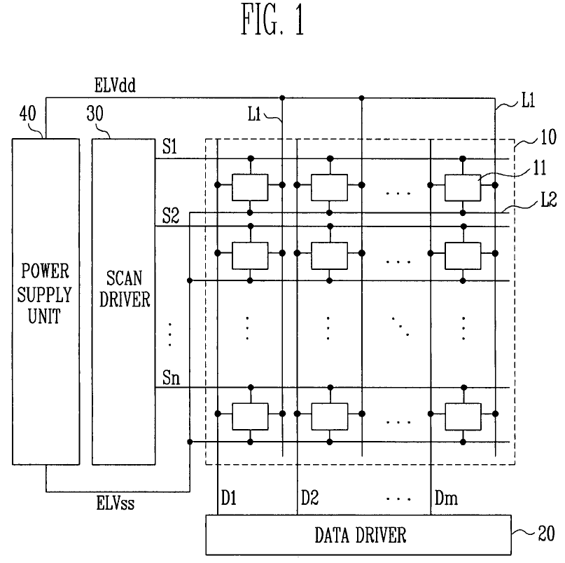

FIG. 1 is a schematic view showing a conventional organic light emitting display device. Referring to FIG. 1, the organic light emitting diode display device includes a pixel unit 10, a data driver 20, a scan driver 30 and a power supply unit 40.

The pixel unit 10 has a plurality of pixels 11 arranged therein, and organic light emitting elements (not shown) are connected to each of the pixels 11. And, the n number of scan lines (S1,S2, . . . Sn-1,Sn) formed in a horizontal direction and configured to transmit a scan signal; the m number of data lines (D1, D2, . . . Dm-1, Dm) formed in a vertical direction and configured to transmit a data signal; the m number of first power supply lines (L1) configured to transmit a first power source; and the m number of second power supply lines (L2) for transmitting a second power source (ELVss) having a lower electric potential than that of the first power source (ELVdd) are formed in pixel unit 10. The pixel unit 10 displays an image by allowing the luminous elements to emit the lights by means of the scan signal, the data signal, the first power source (ELVdd) and the second power source (ELVss).

The data driver 20 is configured to apply a data signal to the pixel unit 10, and is connected to the data lines (D1, D2, . . . Dm-1, Dm) of the pixel unit 10 to apply the data signal to the pixel unit 10.

The scan driver 30 is a unit for sequentially outputting a scan signal and connected to the scan lines (S1,S2, . . . Sn-1,Sn) to supply the scan signal to a specific row of the pixel unit 10. The data signal inputted in the data driver 20 is applied to the specific row of the pixel unit 10 to which the scan signals are supplied to display an image, where one frame is completed if all rows are selected.

The power supply unit 40 transmits a first power source (ELVdd) and a second power source (ELVss) to the pixel unit 10, the second power source (ELVss) having a lower electric potential than the first power source (ELVdd), and therefore an electric current corresponding to the data signal is allowed to flow in each of the pixels 1 due to a voltage difference of the first power source (ELVdd) and the second power source (ELVss).

The mobile phone has various functions such as short message service, memo, etc. in addition to the telecommunication, and the functions such as the telecommunication, the short message service, the memo, etc. may be performed simultaneously. Accordingly, a short message may be checked and a short memo may be sent while talking over the mobile phone. However, if the display is used for checking the short message while talking over the mobile phone, etc., then the mobile phone consumes an electric current for the telecommunication activity and also consumes an electric current for the display on the mobile phone, and therefore an electric current consumption is increased in the mobile phone. In particular, the more electric current may be consumed if the display has a high luminance.

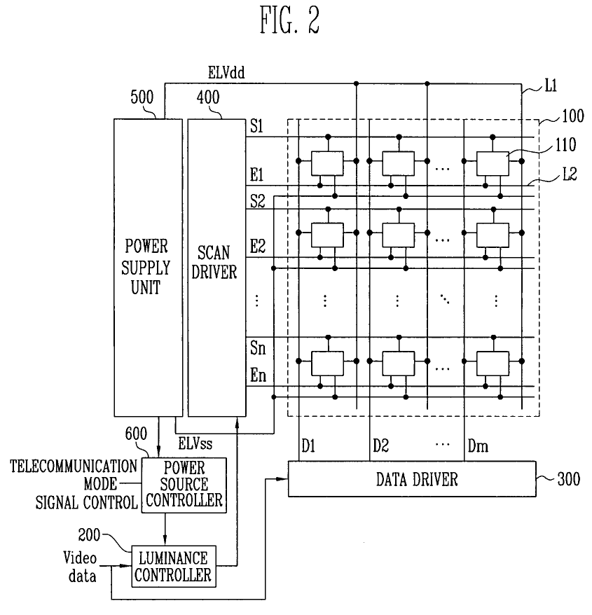

FIG. 2 is a schematic view showing an organic light emitting diode display device which can be used in a device with optional display functionality. Referring to FIG. 2, the organic light emitting diode display device may, for example, be used in a display for displaying an image on a mobile phone, and includes a pixel unit 100, a luminance controller 200, a data driver 300, a scan driver 400, a power supply unit 500 and a power source controller 600.

The pixel unit 100 has a plurality of pixels 110 arranged therein, and organic light emitting elements (not shown) are connected to each of the pixels 110. And, the n number of scan lines (S1,S2, . . . Sn-1,Sn) formed in a horizontal direction and configured to transmit a scan signal; the n number of light emission control signal lines (E1,E2, . . . En-1,En) configured to transmit a light emission control signal; the m number of data lines (D1, D2, . . . Dm-1, Dm) formed in a vertical direction and configured to transmit a data signal; a first power line (L1) configured to transmit a first power source (ELVdd) to pixels; and a second power line (L2) configured to transmit a second power source (ELVss) to pixels are formed on pixel unit 100. In some embodiments, the second power line (L2) may be electrically connected to each of the pixels 110 since it is equivalently placed and formed over the pixel unit 100.

The luminance controller 200 limits display luminance so that luminance of the pixel unit 100 can not exceed a certain level. The luminance of the pixel unit 100 is higher when an area for emitting the light with a high luminance is larger in the pixel unit 100 than when an area for emitting the light with a high luminance is smaller in the pixel unit 100. For example, the pixel unit 100 has a higher luminance when it emits the light with a full white color than when it does not emit light with a full white color. Accordingly, if the area for emitting the light with a high luminance is large, as described above, its luminance is decreased to a certain level prior to display. A luminance limit is varied depending on the area emitting the light with a high luminance, and therefore a luminance is allowed to be varied in the entire pixel unit 100 depending on the change of the area emitting the light with a high luminance.

The luminance controller 200 judges a size of the frame data which is the sum of components of the video data signal inputted into one frame, and then judges that a current capacity, which flows to the pixel unit 100 emitting the light brightly, is large if the size of the frame data is large, and determines that a current capacity which flows to the pixel unit 100 is small if the size of the frame data is small. Accordingly, the luminance controller 200 outputs a luminance control signal for limiting a luminance if the size of the frame data signal exceeds a predetermined value, and therefore the entire brightness of images displayed in the pixel unit 100 is reduced to display the images.

If the brightness of the pixel unit 100 is limited by the luminance controller 200, then the current to the pixel unit 100 is limited, and therefore the pixel unit 100 does not require the power supply unit 500 to have a high power. And, if the luminance of the pixel unit 100 is not limited, then display luminance is enhanced since an emission time of the emitting pixels is maintained for an extended time, resulting in an enhanced aspect ratio of the emitting pixels and the non-emitting pixels. Accordingly, the aspect ratio of the pixel unit 100 is improved.

Accordingly, if the emission time of the pixels is decreased to reduce a current flowing to the pixel unit 100, then the current flowing to the pixel unit 100 may be reduced since a supply time of the electric current is reduced.

In order to control emission time of the pixel unit 100, the luminance controller 200 controls a pulse width of the light emission control signal transmitted through the light emission control signal lines (E1,E2, . . . En-1,En). Accordingly, an electric current flowing into the pixel unit 100 increases if the light emission control signal has a long pulse width, and an electric current flowing into the pixel unit 100 decreases if the light emission control signal has a short pulse width.

Also, a power consumption of the mobile phone may be reduced by lowering an electric current consumed in the luminance controller 200 since the luminance controller 200 is driven if the mobile phone is in a telecommunication mode, but the luminance controller 200 is not operated if the mobile phone is out of the telecommunication mode.

The data driver 300 is a unit for applying a data signal to the pixel unit 100, and receives a video data having red, blue and green elements to generate a data signal. And, the data driver 300 is connected to the data lines (D1, D2, . . . Dm-1, Dm) of the pixel unit 100 to apply the generated data signal to the pixel unit 100.

The scan driver 400 is a unit for applying a scan signal and a light emission control signal to the pixel unit 100, and the scan driver 400 is connected to the scan lines (S1,S2, . . . Sn-1,Sn) and the light emission signal lines (E1,E2, . . . En-1,En) to transmit the scan signal and the light emission control signal to a certain row of the pixel unit 100. The data signal output from the data driver 300 is transmitted to the pixel 110 to which the scan signal is transmitted, and the pixel 110 to which the light emission control signal is transmitted emits the light depending on the light emission control signal.

The scan driver 400 is divided into two circuits: a scan driving circuit for generating scan signals; and a light emission driving circuit for generating light emission control signals. Therefore, the scan driving circuit and the light emission driving circuit may be included in one part, or presented as a separate parts.

The data signal input to the data driver 300 is applied to a certain row of the pixel unit 100 to which the scan signal is transmitted, and an electric current corresponding to the data signal is transmitted to the luminous elements to display an image by allowing the luminous elements to emit the light. At this time, one frame is completed after all rows are selected.

The power supply unit 500 transmits the first power source (ELVdd) and the second power source (ELVss) to the pixel unit 400, which allows an electric current, corresponding to the data signal, to flow in each of the pixels due to a difference between the first power source (ELVdd) and the second power source (ELVss). And, a power source is selectively transmitted to the luminance controller 200 by means of the controller 600, and therefore the luminance controller 200 selectively receives the power source so that the luminance controller 200 can be driven.

The power source controller 600 receives a telecommunication mode control signal to determine whether the mobile phone is in a telecommunication mode. At this time, power consumption may be reduced by driving the luminance controller 200 to display an image in the pixel unit 100 to correspond to the sum of the components of the data signal inputted during one frame period if the mobile phone is in a telecommunication mode.

Another embodiment is a large electric current is consumed if the mobile phone is in a telecommunication mode. If the increase in power consumption appears in apparatuses using a charged battery such as the mobile phones, then the mobile phone may not be used for a long time. Accordingly, if users see a picture while talking over the mobile phone, then the power source controller 600 prevents the mobile phone from being unexpectedly cut off by reducing a power consumption if the display is used while talking over the mobile phone.

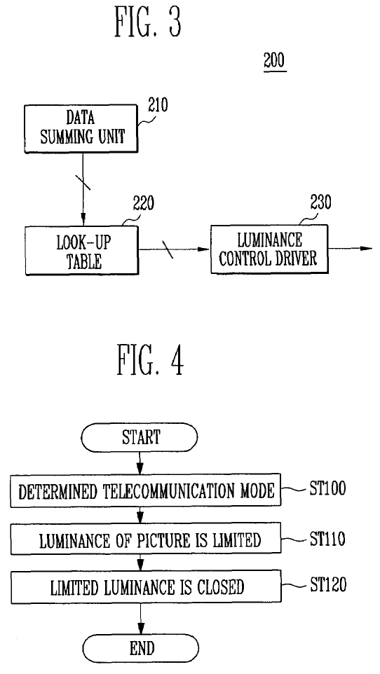

FIG. 3 is a block diagram showing one embodiment of a luminance controller used for the organic light emitting diode display device. Referring to FIG. 3, the luminance controller 200 is operated in a telecommunication mode, and includes a data summing unit 210, a look-up table 220 and a luminance control driver 230.

The data summing unit 210 extracts information about frame data and sums up video data having information about red, blue and green colors input into one frame. Since the frame data sums up all video data of one frame, the luminance of the display can be modified such that if the video data has a large amount of data, a high luminance is used, and if the video data has a small amount of data, a low luminance is used.

The look-up table 220 assigns a width of a light emission period for the light emission control signal depending on the data value of the frame data. Upper bits of the frame data may be used to assign a width of the light emission period. For example, the upper 5 bits of the frame data may be used to determine a brightness level of the pixel unit 100 in one frame.

Accordingly, the luminance of the pixel unit 100 is increased as the size of the frame data increases, and the luminance of the pixel unit 100 is limited if the brightness exceeds a predetermined brightness. Also, the luminance of the pixel unit 100 may be prevented from being enhanced beyond a limit since the luminance of the pixel unit 100 is limited increasingly as the luminance of the pixel unit 100 increases.

If the luminance of the pixel unit 100 is limited uniformly as the luminance of the pixel unit 100 increases, a very bright picture is provided when the pixel unit 100 displays a very high luminance since the luminance is excessively limited by the luminance limit, indicating that the overall brightness is simply reduced. Accordingly, the luminance of the pixel unit 100 is prevented from falling below a minimum luminance limit by assigning the luminance limit to the pixel unit 100 if the entire pixel unit 100 expresses a white color by setting the luminance to the maximum limit.

And, the luminance is set not to be limited if the size of the frame data does not exceed a certain size, and therefore the luminance is set not to be limited if the luminance is not high.

Table 1 lists one example of a look-up table, where a light emission ratio is limited to a range of 50% of the maximum value depending on the number of the pixels emitting the light with a luminance over the luminance limit.

TABLE 1

| | Light | | | Width of Light |
|---|---|---|---|---|
| Upper 5 | emission | Light | | emission control |
| bit value | rate | emission ratio | Luminance | signal |
| 0 | 0% | 100% | 300 | 325 |
| 1 | 4% | 100% | 300 | 325 |
| 2 | 7% | 100% | 300 | 325 |
| 3 | 11% | 100% | 300 | 325 |
| 4 | 14% | 100% | 300 | 325 |
| 5 | 18% | 100% | 300 | 325 |
| 6 | 22% | 100% | 300 | 325 |
| 7 | 25% | 100% | 300 | 325 |
| 8 | 29% | 100% | 300 | 325 |
| 9 | 33% | 100% | 300 | 325 |
| 10 | 36% | 100% | 300 | 325 |
| 11 | 40% | 99% | 297 | 322 |
| 12 | 43% | 98% | 295 | 320 |
| 13 | 47% | 96% | 287 | 311 |
| 14 | 51% | 93% | 280 | 303 |
| 15 | 54% | 89% | 268 | 290 |
| 16 | 58% | 85% | 255 | 276 |
| 17 | 61% | 81% | 242 | 262 |
| 18 | 65% | 76% | 228 | 247 |
| 19 | 69% | 72% | 217 | 235 |
| 20 | 72% | 69% | 206 | 223 |
| 21 | 76% | 65% | 196 | 212 |
| 22 | 79% | 62% | 186 | 202 |
| 23 | 83% | 60% | 179 | 194 |
| 24 | 87% | 57% | 172 | 186 |
| 25 | 90% | 55% | 165 | 179 |
| 26 | 94% | 53% | 159 | 172 |
| 27 | 98% | 51% | 152 | 165 |
| 28 | — | — | — | — |
| 29 | — | — | — | — |
| 30 | — | — | — | — |
| 31 | — | — | — | — |

In this example, since the luminance is not limited if the portion of the luminous area emitting the light with the maximum luminance is less than 36%, and the luminance is limited if the portion of the luminous area emitting the light with the maximum luminance exceeds 36%, a limitation ratio of the luminance is also increased if the area emitting the light with the maximum luminance increases. And, since the maximum limitation ratio of the luminance is set to 50% to prevent the luminance from being limited excessively, the limitation ratio of the luminance is not lowered to a range of 50% or less even though the most pixels of the pixel unit 100 emit the light with the maximum luminance.

Table 2 lists another example of a look-up table, and the light emission ratio is limited to a range of 33% of the maximum value depending on the number of the pixels emitting the light with a luminance over the predetermined limit.

TABLE 2

| | Light | | | Width of Light |
|---|---|---|---|---|
| Upper 5 | emission | Light | | emission control |
| bit value | rate | emission ratio | Luminance | signal |
| 0 | 0% | 100% | 300 | 325 |
| 1 | 4% | 100% | 300 | 325 |
| 2 | 7% | 100% | 300 | 325 |
| 3 | 11% | 100% | 300 | 325 |
| 4 | 14% | 100% | 300 | 325 |
| 5 | 18% | 99% | 298 | 322 |
| 6 | 22% | 98% | 295 | 320 |
| 7 | 25% | 95% | 285 | 309 |
| 8 | 29% | 92% | 275 | 298 |
| 9 | 33% | 88% | 263 | 284 |
| 10 | 36% | 83% | 250 | 271 |
| 11 | 40% | 79% | 237 | 257 |
| 12 | 43% | 75% | 224 | 243 |
| 13 | 47% | 70% | 209 | 226 |
| 14 | 51% | 64% | 193 | 209 |
| 15 | 54% | 61% | 182 | 197 |
| 16 | 58% | 57% | 170 | 184 |
| 17 | 61% | 53% | 160 | 173 |
| 18 | 65% | 50% | 150 | 163 |
| 19 | 69% | 48% | 143 | 155 |
| 20 | 72% | 45% | 136 | 147 |
| 21 | 76% | 43% | 130 | 141 |
| 22 | 79% | 41% | 124 | 134 |
| 23 | 83% | 40% | 119 | 128 |
| 24 | 87% | 38% | 113 | 122 |
| 25 | 90% | 36% | 109 | 118 |
| 26 | 94% | 35% | 104 | 113 |
| 27 | 98% | 34% | 101 | 109 |
| 28 | — | — | — | — |
| 29 | — | — | — | — |
| 30 | — | — | — | — |
| 31 | — | — | — | — |

In this example, since the luminance is not limited if the portion of the luminous area emitting the light with the maximum luminance is less than 34%, and the luminance is limited if the portion of the luminous area emitting the light with the maximum luminance exceeds 34%, a limitation ratio of the luminance is also increased if the area emitting the light with the maximum luminance increases. And, since the maximum limitation ratio of the luminance is set to 33% to prevent the luminance from being limited excessively, the limitation ratio of the luminance is not lowered to a range of 33% or less even though the most pixels of the pixel unit 100 emit the light with the maximum luminance.

In some embodiments, the luminance control driver 230 receives an upper 5-bit value to output a luminance control signal. The light emission control signal is output to the scan driver 400 depending on the luminance control signal so that the luminance control signal controls the scan driver 400. In particular, if the scan driver 400 is divided into a scan driving circuit and a light emission control circuit, then the light emission control signal is output depending on the luminance control signal since the luminance control signal is input to the light emission control circuit.

In some embodiments, the maximum light emission period of the light emission control signal is set to 325 periods. Accordingly, 8 bits can express 256 values and 9 bits can express 512 values, and therefore the luminance control signal preferably outputs a 9-bit signal to generate a light emission period of the light emission control signal, as listed in Table 1. The luminance control signal may use a start pulse, and the width of the light emission control signal may be determined by the width of the start pulse.

FIG. 4 is a flowchart illustrating a method for driving the organic light emitting diode display device.

Step 1 (ST 100): it is determined whether the mobile phone is in a telecommunication mode. Since the mobile phone consumes a large electric current in a telecommunication mode, a power consumption of the mobile phone is increased if the mobile phone is in a telecommunication mode when a user sees a picture of the mobile phone. Accordingly, it is determined whether the mobile phone is in a telecommunication mode in order to prevent an unnecessary increase in power consumption.

Step 2 (ST 110): luminance of the display is limited if a user sees a picture of the mobile phone when the mobile phone is in a telecommunication mode. Another embodiment is a luminance limit of the picture may reduce the electric current consumed in the picture if the picture emits the light with a high luminance by increasing the luminance limit when the grey level sum of the components of the data signal is larger than the grey level sum of the components of the data signal input during one frame period and by reducing the luminance limit when the grey level sum is smaller than the grey level sum of the data signal. If the user sees a picture of the mobile phone, for example the user may check a short message and take a memo while talking over the mobile phone.

Step 3 (ST 120): If the telecommunication mode is finished and the picture of the mobile phone is not used anymore, the luminance limit of the picture on the mobile phone is closed. If the telecommunication mode is finished, then the luminance limit is not required for reducing a power consumption due to a reduction in the electric current consumption. The mobile phone is mainly used for telecommunication if it is in a telecommunication mode, but the mobile phone is mainly used for displaying a picture if the mobile phone is used to see the picture when the mobile phone is out of the telecommunication mode, and therefore the luminance does not need to be limited anymore. The power consumed in the luminance controller may be reduced by stopping the luminance controller from limiting the luminance since the luminance does not need to be limited if a picture of the mobile phone is not used anymore. And, if the picture of the mobile phone is not used anymore when the mobile phone is in a telecommunication mode, then a power consumption may be reduced since a power source transmitted to the picture of the mobile phone is cut off, or a luminance of the picture on the mobile phone is lowered.

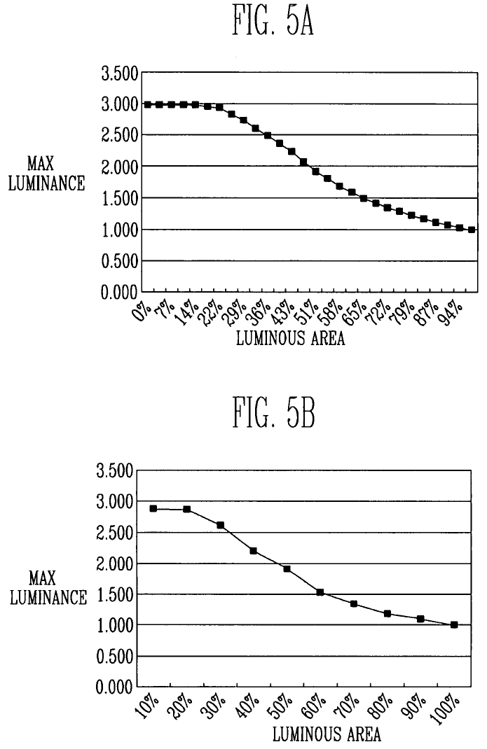

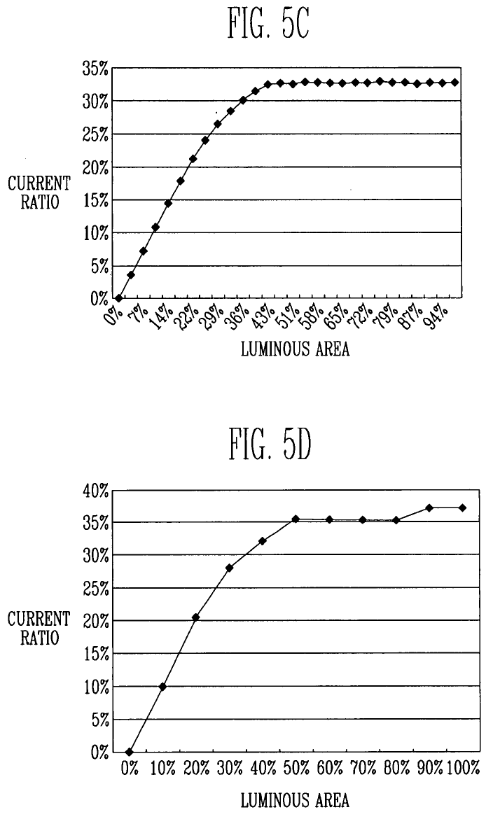

FIG. 5a through FIG. 5d are diagrams showing that the light emission ratio of the light emission control signal is limited to 33% of the maximum electric current capacity. FIG. 5a shows a relation between a luminous area and a luminance ratio which are calculated mathematically, and FIG. 5b shows a relation between a luminous area and a luminance ratio which are actually measured. And, FIG. 5c shows a relation between a luminous area and a luminance ratio which are calculated mathematically, and FIG. 5d shows a relation between a luminous area and a luminance ratio which are actually measured.

Referring to FIG. 5a and FIG. 5b, a picture is not darkened since the luminance is maintained to a constant level if an area occupied by pixels emitting the light with a luminance over a limit is less than about 30%. Also, the luminance is gradually limited to prevent glares by preventing a picture from being displayed at an excessively bright level if an area occupied by pixels emitting the light with a luminance over a limit is in a range of about 30%.

Referring to FIG. 5c and FIG. 5d, the power supply unit 500 does not need to source a high power since a load applied to the power supply unit 500 is decreased if the current under the brightness limit ranges from approximately 30% to approximately 35% of the current capacity flowing without the brightness limit.

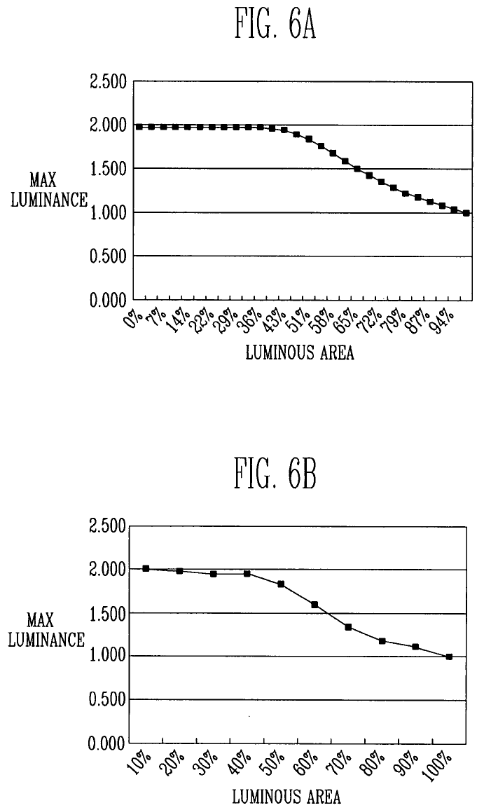

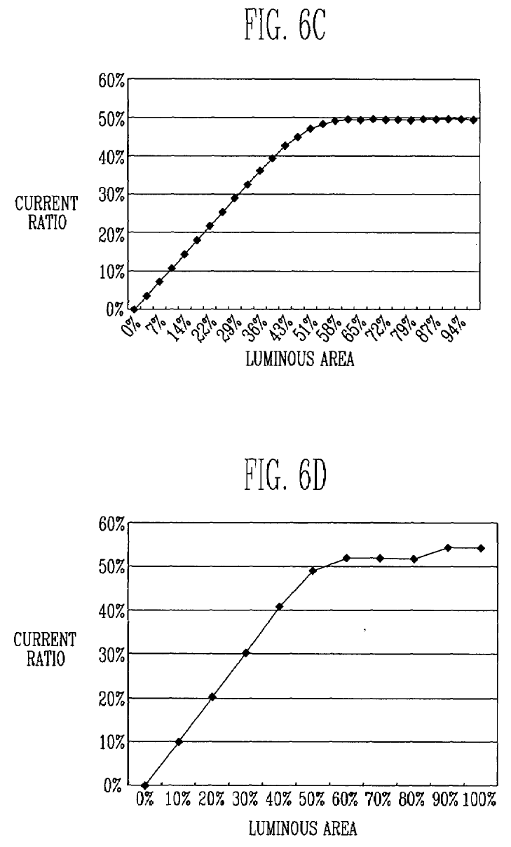

FIG. 6a through FIG. 6d are diagrams showing that the light emission ratio of the light emission control signal is limited to about 50% of the maximum electric current. FIG. 6a shows the relation between the luminous area and the luminance ratio which are calculated mathematically, and FIG. 6b shows the relation between the luminous area and the luminance ratio which are actually measured. And, FIG. 6c shows the relation between the luminous area and the luminance ratio which are calculated mathematically, and FIG. 6d shows the relation between the luminous area and the luminance ratio which are actually measured.

Referring to FIG. 6a and FIG. 6b, the luminance is maintained at a constant level if the area occupied by pixels emitting light with a luminance over a limit is less than about 40%, and the luminance is gradually diminished to prevent glares by preventing a picture from being displayed at an excessively bright level if an area occupied by pixels emitting light with a luminance over a limit is in a range of about 40% or more.

Referring to FIG. 6c and FIG. 6d, the power supply unit 500 does not to source a high power since the load applied to the power supply unit 500 is decreased if the current under the brightness limit is approximately 50% of the current capacity flowing without the brightness limit.

The organic light emitting diode display device and the driving method thereof may be useful to prevent a power consumption from being increased when an electric current is suddenly increased because a user talks over the mobile phone while displaying an image on the mobile phone since a range of an increasing current may be decreased if the luminance of the image is limited to reduce an electric current flowing to the organic light emitting display device.

The description proposed herein is an example for the purpose of illustrations only, not intended to limit the scope of the invention, so it should be understood that other equivalents and modifications could be made thereto without departing from the spirit and scope of the invention as apparent to those skilled in the art

What is claimed is:

1. An organic light emitting diode display device for use in a mobile phone, the device comprising:
a pixel unit comprising a plurality of pixels configured to receive a plurality of scan signals, a plurality of light emission control signals and a plurality of data signals to display an image;
a scan driver configured to transmit the scan signals and the light emission control signals to the pixel unit;
a data driver comprising a video data configured to generate the plurality of data signals and to transmit the generated data signals to the pixel unit;
a power source controller configured to determine whether the mobile phone is in a telecommunication mode; and
a luminance controller configured to control an emission time of the pixel unit by determining a luminance limit of the pixel unit, the luminance limit corresponding to the size of the video data when the mobile phone is determined to be in a telecommunication mode.

2. The organic light emitting diode display device according to claim 1, wherein the emission time of the pixel unit is controlled depending on a size of frame data.

3. The organic light emitting diode display device according to claim 1, wherein the scan driver is divided into a scan driving circuit configured to transmit the scan signal and a light emission control driving circuit configured to transmit the light emission control signal, wherein a luminance control signal controls the light emission control driving circuit.

4. The organic light emitting diode display device according to claim 1, wherein the luminance controller comprises:
a data summing unit configured to sum a data signal input during one frame period;
a look-up table configured to store the luminance limit corresponding to the summed value of the data signal; and
a luminance controller configured to receive the luminance limit from the look-up table.

5. The organic light emitting diode display device according to claim 4, wherein a pulse width of the plurality of light emission control signals is controlled by the luminance controller.

6. The organic light emitting diode display device according to claim 1, further comprising a power supply unit configured to supply power to the pixel unit.

7. Another embodiment is a method of driving an organic light emitting diode display device which displays an image on a mobile phone, the method comprising:
determining whether the mobile phone is in a telecommunication mode;
determining the sum of components of a data signal; and
displaying the image at a time corresponding to the sum of the components of the data signal.

8. The method of driving an organic light emitting diode display device according to claim 7, wherein the sum of the components of the data signal is determined by summing up the data signal input during one frame period.

9. The method of driving an organic light emitting diode display device according to claim 7, wherein determining whether the mobile phone is in a telecommunication mode occurs while displaying the image.

10. The method of driving an organic light emitting diode display device according to claim 7, wherein determining whether the mobile phone is in a telecommunication mode occurs prior to displaying the image.

11. An organic light emitting diode display device configured to be used for a mobile phone, the device comprising a display controller configured to modify display power based at least in part on whether the mobile phone is in a telecommunication mode, wherein the display controller is configured to reduce the power if the video data indicates that a portion of the display device greater than a threshold is to be illuminated.

12. The device of claim 11, wherein the display controller is configured to reduce the display power if the mobile phone is in a telecommunication mode.

13. The device of claim 12, wherein the luminance of the display is reduced as a result of reducing the display power.

14. The device of claim 11, wherein the display controller is further configured to modify the display power based at least in part on image data of at least a portion of an image to be displayed.

15. The device of claim 11, wherein the threshold is about 40%.

16. The device of claim 14, wherein the display controller is configured to reduce the power by an amount based at least in part on the portion of the display to be illuminated.

17. The device of claim 16, wherein the amount of reduction increases with increasing illuminated display portion.

18. The device of claim 14, wherein the display controller is configured to reduce the display power by about 50%.

19. The device of claim 11, further comprising a power control circuit configured to reduce power to the display controller when the mobile phone is not in a telecommunication mode.

20. The device of claim 19, wherein the power control circuit is further configured to disable the display controller when the mobile phone is not in a telecommunication mode.
